(19) United States
(12) Patent Application Publication
(10) Pub. No.: US 2003/0179468 A1
(43) Pub. Date: Sep. 25, 2003

(54) Optical component

(76) Inventors: Sean Chang, Tao Yuan County (TW); Shih-Shiun Chang, Kaohsiung County (TW)

Correspondence Address: MARTINE & PENILLA, LLP, 710 LAKEWAY DRIVE, SUITE 170, SUNNYVALE, CA, 94085, US

(21) Appl. No.: 10/286,040

(22) Filed: Nov. 1, 2002

(30) Foreign Application Priority Data
Mar. 20, 2002 (TW) 91203463

(51) Int. Cl. G02B 3/06; G02B 13/18

(52) U.S. Cl. 359/710

(57) ABSTRACT

An optical component includes a glass body having a spin axis. The glass body has a first plane and a second plane parallel to the first one. The spin axis passes through the glass body, and is substantially perpendicular to the normal direction of the first plane and the second plane.

### BACKGROUND OF THE INVENTION

1. Field of the Invention

The invention relates to an optical component and, in particular, to an optical component for shifting a light path in parallel.

2. Description of the Related Art

In some optical communication devices, such as a reconfigurable optical add/drop multiplexer (ROADM), an optical switch, or a tunable filter, there exists an optical component to shift a light path in parallel.

FIG. 1 shows a conventional optical component to shift the path of a light in parallel. As shown in FIG. 1, in the optical component 101, a flat glass 102 is placed on a support 104, and the flat glass 102 and the support 104 are pivotally connected to a rotating shaft 103. When a light 105 is incident from outside, a driving means (not shown in the figure), such as a motor and a screw, drives the rotating shaft 103. Then, the flat glass 102 fixed to the support 104 is rotated to a specific angle along the rotating shaft 103 so that the light refracted by the flat glass 102 is shifted in parallel from the light path 106 to the light path 106′.

An optical component used to shift a light path in parallel requires prompt response so as to minimize the transmission loss of optical signals caused by the switch of the light path. However, since the conventional optical component which utilizes a flat glass has a complicated mechanism composed of many components, it is difficult to miniaturize the conventional optical component, and to achieve its objective of the prompt response to the light path switching. Furthermore, since the shifted distance is in linear proportion to the thickness of the flat glass, the weight and volume of the flat glass will be increased as a larger shifted distance is desired. This further reduces the overall responding speed of the optical device, and causes more transmission loss when transmitting the light signals.

### SUMMARY OF THE INVENTION

In view of the above, an objective of the invention is to provide an optical component that has a compact structure with a reduced weight and volume. The responding speed of the component can be increased so that the light path can be shifted quickly in parallel and the transmission loss can be reduced effectively.

To achieve the above-mentioned objective, the optical component according to the invention includes a glass body having a spin axis, a first plane and a second plane parallel to the first one. The spin axis is located in the glass body itself, and its direction is substantially perpendicular to the normal directions of the first plane and the second plane.

In an embodiment, the spin axis passes through the center of gravity of the glass body, and the glass body can have symmetrical shape with respect to the spin axis.

In another embodiment, the glass body has blind holes. The shape of the blind hole may be conical or cylindrical. One end of a rotating shaft may be inserted and fixed in the blind hole. The rotating shaft can be tightly fit with the blind hole.

In still another embodiment, the glass body is an integrally formed with the rotating shaft.

In still another embodiment, a pair of symmetrical bearings is used to support the glass body.

In still another embodiment, the glass body has two circular arcs. The radiuses of curvature of the circular arcs are substantially the same, and the centers of the circular arcs are located on the spin axis.

According to the invention, since the glass body rotates along the spin axis that passes through itself, the optical component is provided with higher responding speed. Moreover, since the optical component may not need any support to connect the glass body and the rotation shaft as the prior art, the size and weight of the optical component can be reduced. Therefore, the optical component according to the invention has a simpler design and a faster responding speed, and can reduce the transmission loss while shifting the light path of an optical signal.

### BRIEF DESCRIPTION OF THE DRAWINGS

FIG. 1 is a schematic view showing an optical component used to shift the light path in parallel in the prior art.

FIG. 2 is a perspective view showing an optical component for shifting a light path in parallel according to an embodiment of the invention.

FIG. 3 is a front view showing an optical component for shifting a light path in parallel according to an embodiment of the invention.

FIG. 4 is a front view showing an optical component provided with a conical-shape blind hole of the invention.

FIG. 5 is a schematic view showing the optical component in which external rotating shafts are inserted and fixed.

FIG. 6 is a top view showing the manner of operation of the optical component according to the embodiment of the invention.

FIG. 7 is a perspective view showing the optical component according to another embodiment of the invention.

FIG. 8 is the front view of the optical component shown in FIG. 7.

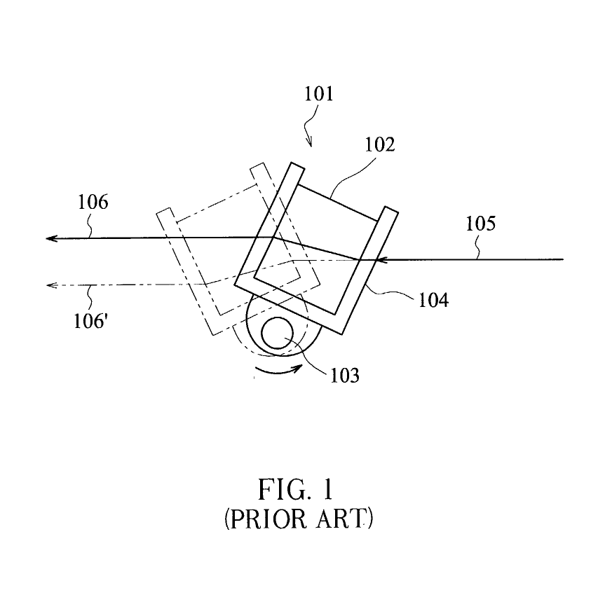

### DETAILED DESCRIPTION OF THE PREFERRED EMBODIMENTS

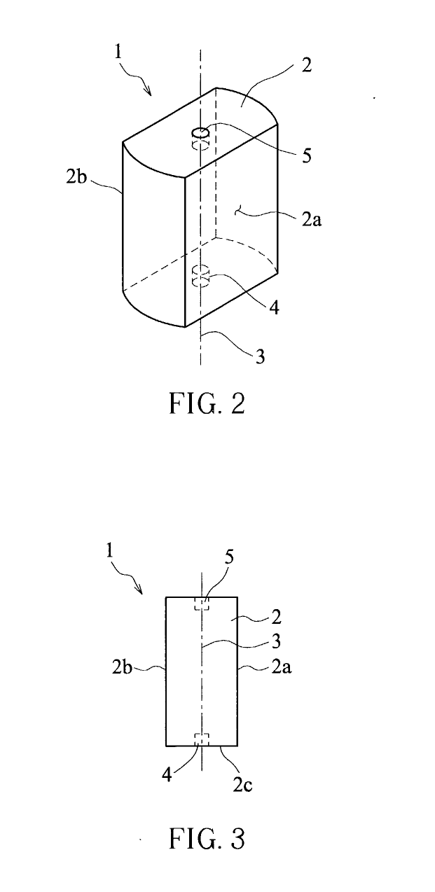

FIG. 2 is a perspective view showing an optical component 1 for shifting a light path in parallel according to the first embodiment of the invention, and FIG. 3 is a front view of the optical component 1 shown in FIG. 2. As shown in FIG. 2 and FIG. 3, the optical component 1 includes a glass body 2. The glass body 2 has a first plane 2a and a second plane 2b parallel to the first one. Incident rays of light enter the glass body 2 at the first plane 2a, and then leave it at the second plane 2b after being refracted. The glass body 2 has a spin axis 3 which is substantially perpendicular to the normal direction of the first plane 2a and the second plane 2b.

In the current embodiment, the glass cylinder is ground to form the glass body 2 with a pair of parallel surfaces. Therefore, the glass body 2 has two circular arcs having equal radiuses of curvature, and the centers of the circular arcs both locate on the spin axis; in other words, the spin axis 3 passes through the center of gravity of the glass body 2.

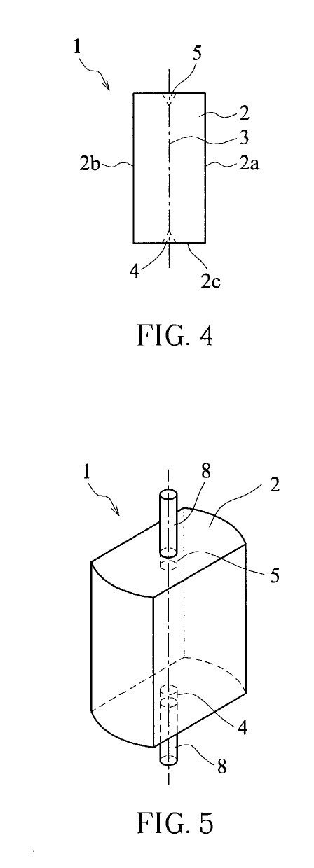

In addition, two blind holes 4 and 5 can be formed on the glass body 2. The blind holes 4 and 5 may have a cylindrical shape shown in FIG. 3, or a conical shape shown in FIG. 4. FIG. 5 is a schematic diagram showing rotating shafts 8 coupled onto the optical component 1 of the invention. As shown in FIG. 5, the size of the blind holes 4 and 5 is designed to match up with external rotating shafts 8 so that one end of the rotating shafts can be tightly fitted and fixed in the blind holes 4 and 5, respectively.

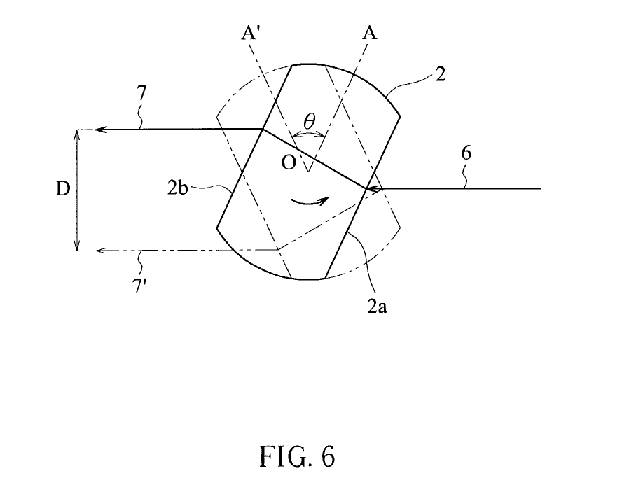

FIG. 6 is a top view showing the manner of operation of the optical component 1 according to the embodiment of the invention. First, the glass body 2 is located at the position O-A. Light 6 is incident on the first plane 2a of the glass body 2 and leaves at the second plane 2b. Since the first plane 2a and second plane 2b are parallel, the light 6 will travel on a light path 7 parallel to the original path after being refracted by the glass body 2.

After being driven by a power source (not shown), the glass body 2 is rotated to an angle θ from the position O-A to a new one denoted as O-A′. At this time, the light 6 will travel on a light path 7′ which is parallel to the light path 7 after being refracted by the glass body 2. The light path 7′ and the light path 7 are separated by a shift distance denoted as D.

Due to the fact that the glass body 2 rotates about the spin axis 3 that passes through itself, the glass body 2 can provide the same shift distance D as the conventional optical component can do, while the required movement of the glass body 2 is less than that of the conventional optical component to attain the same rotating angle θ. In other words, the optical component 1 of the present invention is provided with higher responding speed. Moreover, since the optical component 1 may not need any support to connect the glass body and the rotation shaft as the prior art, the size and weight of the optical component can be reduced. Therefore, the optical component according to the embodiment has a compact design and prompt response compared with the optical component in the prior art.

Furthermore, since the shift distance D is proportional to the thickness of the glass body, when a larger shift distance is required, the size and weight of the glass body will be increased accordingly. Therefore, it is advantageous to apply the present invention, which has a compact design, to reduce the size and weight.

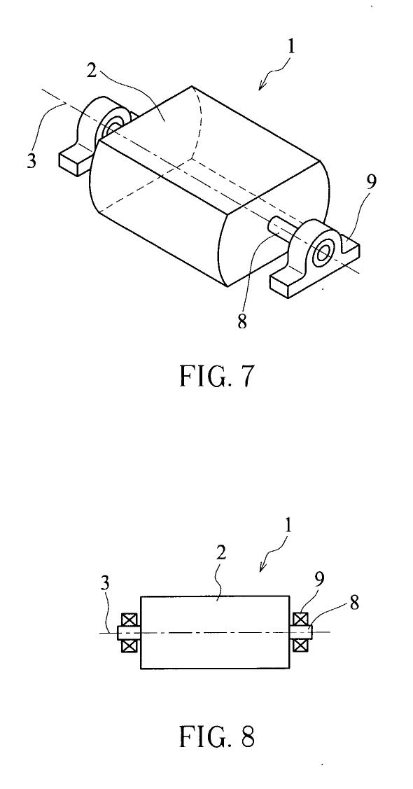

FIG. 7 is a perspective view showing the optical component 1 according to another embodiment of the invention. FIG. 8 is the front view of the optical component 1 shown in FIG. 7. As shown in FIG. 7 and FIG. 8, a pair of rotating shafts 8 are integrally formed, by grinding, at the two ends of the glass body 2. When the rotating shafts 8 of the glass body 2 is driven by a power source (not shown in the figures), the glass body 2 and the rotating shafts 8 rotate along a spin axis 3 to shift the light path of a incident light in parallel.

Furthermore, as shown in FIG. 7 and FIG. 8, the glass body 2 can be supported by a pair of symmetrical bearings 9 to fix the position of the glass body 2.

While the invention has been described by way of examples and in terms of embodiments, it is to be understood that the invention is not limited to the disclosed embodiments. For example, the shape of the glass body can be in any form with two surfaces in parallel. Therefore, the scope of the appended claims should be accorded the broadest interpretation so as to encompass all equivalent modifications.

What is claimed is:

1. An optical component, comprising:
a glass body having a spin axis, a first plane and a second plane, wherein
the first plane is parallel to the second plane, and the spin axis of the glass body is substantially perpendicular to the normal direction of the first plane and the second plane.

2. The optical component according to claim 1, wherein the spin axis passes through the center of gravity of the glass body.

3. The optical component according to claim 1, wherein the glass body has symmetrical shape with respect to the spin axis.

4. The optical component according to claim 1, wherein the glass body is provided with a blind hole in which one end of a rotating shaft is inserted and fixed.

5. The optical component according to claim 4, wherein the rotating shaft is tightly fit with the blind hole.

6. The optical component according to claim 4, wherein the blind hole has a cylindrical shape.

7. The optical component according to claim 4, wherein the blind hole has a conical shape.

8. The optical component according to claim 1, further comprising a rotating shaft integrally formed with the glass body.

9. The optical component according to claim 1, wherein the glass body is supported by a pair of symmetrical bearings.

10. The optical component according to claim 1, wherein the glass body has two circular arcs, wherein the radiuses of curvature of the circular arcs are substantially the same, and the centers of the circular arcs are located on the spin axis.
